(19) United States
(12) Patent Application Publication
(10) Pub. No.: US 2002/0075403 A1
(43) Pub. Date: Jun. 20, 2002

(54) System and method for displaying closed captions in an interactive TV environment

(76) Inventors: Samuel T. Barone JR., Culver City, CA (US); Drake Smith, Oxford, CT (US)

Correspondence Address: CHRISTIE, PARKER & HALE, LLP, 350 WEST COLORADO BOULEVARD, SUITE 500, PASADENA, CA, 91105, US

(21) Appl. No.: 09/945,005

(22) Filed: Aug. 31, 2001

Related U.S. Application Data
(60) Provisional application No. 60/230,038, filed on Sep. 1, 2000.

(51) Int. Cl. H04N 7/025; H04N 7/10; G06F 3/00; H04N 5/445; G06F 13/00; H04N 7/16; H04N 7/00; H04N 11/00

(52) U.S. Cl. 348/461; 725/32; 725/43; 725/136

(57) ABSTRACT

The present invention is directed toward a method and system for displaying closed captions encoded in a video program represented by an electronic signal in an interactive television system. In one aspect the present invention may be used to receive the electronic signal and ITV data and to determine if a conflict exists between the screen location of the closed caption and the screen location of the ITV data. If a conflict does exists the present invention relocates the closed captions to a screen location reserved for displaying closed captions.

### CROSS-REFERENCE TO RELATED APPLICATION

This application claims priority to U.S. Provisional Patent application Serial No. 60/230,038, entitled SYSTEM AND METHOD FOR DISPLAYING CLOSED CAPTIONS IN AN INTERACTIVE TV ENVIRONMENT filed on Sep. 1, 2000, the contents of which are incorporated herein by reference.

### FIELD OF THE INVENTION

The present invention relates generally to processing and displaying video data and more particularly to processing and displaying closed captioning data in an interactive television system.

### BACKGROUND

Video data frequently includes data, such as, for example, closed caption text data, that is transmitted during the vertical blanking interval (VBI) of the video signal. The National Television Standards Committee (NTSC) has promulgated a standard format wherein the closed caption text is transmitted during line twenty-one of either the odd or even field of the video frame.

In the United States, conventional television systems, with picture screens 33 cm (13 in) or larger, are mandated to include a closed caption decoder. Closed caption decoders strip the encoded data from the video signal, decode the data, and reformat the data for display, concurrent with the video program, on a television screen. In accordance with standards promulgated by the Federal Communications Commission (FCC), closed caption text consists of up to four rows of text. Conventionally the captioning text may be positioned nearly anywhere on the TV screen. The text may paint-on from left to right, it may pop-on (like a movie subtitle), or it may roll-up (like a newscaster's teleprompter). The failure to standardize the display of closed caption text creates potential conflicts with modern interactive television systems.

Interactive television (“ITV”) combines conventional television with additional content (“interactive content”) to present a viewer with an enhanced television viewing environment that provides game play, supplemental information, or other forms of interactivity. In an interactive TV environment, the main video program image is often reduced in size and positioned in one corner of the TV screen. The remaining area of the screen may be used for ITV text and graphics such as informational screens or prompts for the viewer.

When an interactive TV program is being displayed, conventional ITV receivers often filter or remove the closed caption text from the outgoing video signal. This, in turn, disables the display of caption text on a television connected to the ITV receiver. The caption text is removed to avoid conflicts between the display of caption text and the display of interactive TV text and graphics. For example, if caption text were allowed, it might obscure a critical ITV message or at times, closed caption text may overlay critical areas of a windowed video program image.

Accordingly, it would be advantageous to provide a system and method whereby closed caption data is reformatted for display in an ITV environment. The present invention allows caption text and interactive images to coexist on the same display thereby allowing the hearing impaired to enjoy the benefits of interactive television.

### SUMMARY OF THE INVENTION

In one aspect of the present invention a method for displaying closed captions encoded in a video signal includes allocating a screen area for displaying the closed captions, receiving the video signal and ITV data and relocating the closed captions to the allocated screen area.

In another aspect of the present invention a method of displaying closed captions encoded in a video signal includes receiving the video signal and ITV data, determining if a conflict exists between the screen location of the closed captions and screen location of the ITV data and relocating the closed captions in accordance with the conflict determination.

In another aspect of the present invention a method of displaying closed captions encoded in a video signal includes receiving the video signal and ITV data, determining the screen location of the closed captions, determining the screen location of the ITV data and relocating at least a portion of the closed captions whose screen location conflicts with the screen location of the ITV data.

In a further aspect of the present invention an interactive television receiver includes means for allocating a screen area for displaying closed captions, means for receiving the video signal, means for receiving ITV data and means for relocating the closed captions to the allocated screen area.

### BRIEF DESCRIPTION OF THE DRAWINGS

These and other features, aspects, and advantages of the present invention will become better understood with regard to the following description, appended claims, and accompanying drawings where:

FIG. 1 illustrates a grid indicating where closed captions may be placed on a TV screen;

FIG. 2 illustrates an interactive TV environment in accordance with an exemplary embodiment of the present invention;

FIG. 3 is a system level block diagram of a typical hookup of an interactive TV receiver;

FIG. 4 graphically illustrates an interactive TV environment with conflicting closed caption text;

FIG. 5 is a simplified block diagram of standard interactive TV system;

FIG. 6 is a simplified block diagram of an ITV receiver in accordance with an exemplary embodiment of the present invention;

FIG. 7 is a flow diagram of a interactive TV environment for relocating closed captioning in accordance with an exemplary embodiment of the present invention;

FIG. 8 illustrates an interactive TV environment with reformatted caption text in accordance with an exemplary embodiment of the present invention;

FIG. 9 illustrates what the viewer sees when captions are reformatted for an interactive environment;

FIG. 10 is a flow diagram of an alternative interactive TV environment for relocating closed captioning in accordance with an exemplary embodiment of the present invention;

FIG. 11 is a flow diagram of a further alternative interactive TV environment for relocating closed captioning in accordance with an alternate embodiment of the present invention;

FIG. 12 is a flow diagram of a further alternative interactive TV environment for relocating closed captioning in accordance with an alternate embodiment of the present invention;

FIGS. 13a and 13b graphically illustrate the modification of the row positioning codes to relocate closed caption data to an allocated screen area in accordance with an exemplary embodiment of the present invention;

FIGS. 14a and 14b graphically illustrate the modification of caption positioning codes to resize the caption and relocate the closed caption to an allocated screen area in accordance with an exemplary embodiment of the present invention; and

FIGS. 15a and 15b graphically illustrate the modification of caption positioning codes to separate an incoming caption into two rows and to relocate the closed caption to an allocated screen area in accordance with an exemplary embodiment of the present invention.

### DETAILED DESCRIPTION OF THE INVENTION

In an exemplary embodiment of the present invention, a signal processing system is employed to reformat closed caption text for display in an ITV environment in a way that does not conflict with the displayed interactive images. Television receiver regulations in the United States require televisions with picture screens 33 cm (13 in) or larger be able to process signals which contain information in an encoded data format within line 21, field 1 of the scanned television raster. The processed signal may then be used to display closed captioning information (Federal Communications Commission Report and Order on GEN Docket No. 91-1, dated Apr. 12, 1991). Therefore, most television receivers currently in use in the United States today contain closed caption decoders.

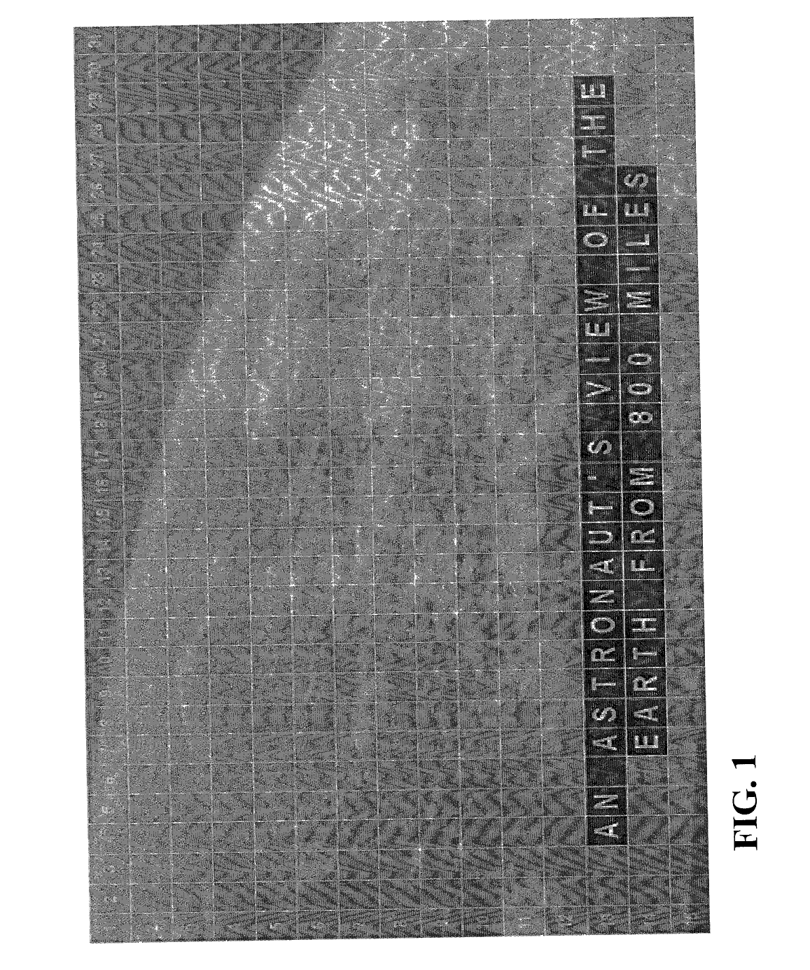

The closed caption standard for NTSC television requires captioning text be positioned on the display screen within a safe caption area. In the NTSC standards the safe caption display area is divided into 15 character rows of text of equal height and 32 columns of equal width as illustrated in FIG. 1. The caption display grid is intended to provide for accurate on screen placement of captioning text. The creator of the captioning data should therefore locate the captioning data within these established columns and rows. In addition, FCC regulations further require that caption characters should be clearly and separately displayed from the video over which they are placed.

In caption mode, text can appear in up to four rows simultaneously anywhere on the screen within the defined display area. In addition, a solid space equal to one column width may be placed before the first character and after the last character of each row to enhance legibility. The caption area will be transparent anywhere that no standard space character or other character has been addressed and no accompanying solid space is needed. In practice, captioning text is displayed in a limited number of rows, typically two or three, to minimize obscuration of the video program. Digital TV closed captioning, as described in the EIA-708 specification, has a similar grid structure.

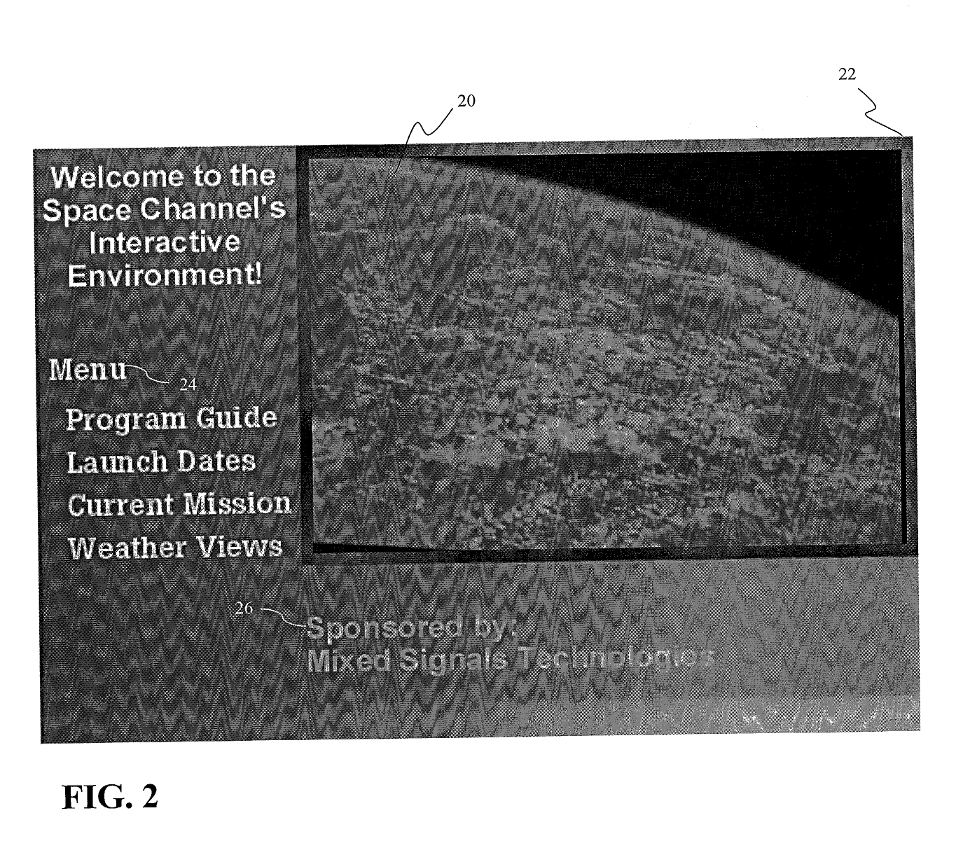

The presentation of an interactive TV program on the other hand is not subject to standardized requirements. A typical interactive TV environment, designed by an ITV author, may consist of text and graphic images that enhance the video program. Typically the creator of the ITV program reduces the size of the video program 20 and locates the program in one corner of the display screen 22 as shown in FIG. 2. In this particular example, the ITV author has reduced the size of the video image and located it in the upper right corner of the display screen. The ITV author may freely utilize the remaining space on the display screen to provide a menu of choices 24 for the ITV viewer together with advertisements 26 or other interactive content.

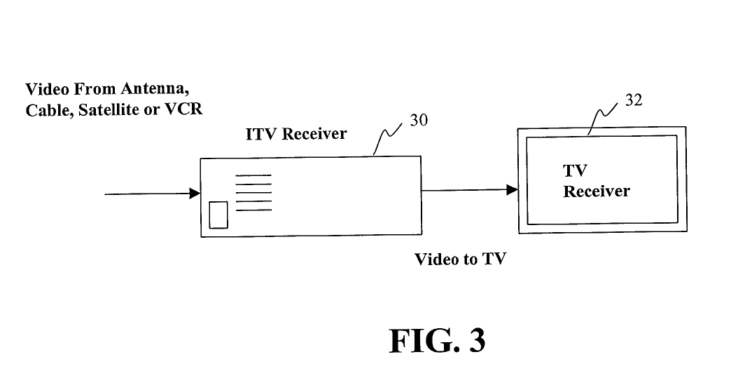

Referring to FIG. 3, for a conventional interactive TV system, the video signal is first processed by an ITV receiver 30 before being conveyed to a TV receiver 32. Consequently, the closed caption decoder function (typically resident in the TV) occurs after the ITV function so that the captioning may still be displayed anywhere on the entire TV screen, and is not limited to the reduced video image that typically appears in one corner of the screen. Therefore, it is probable that in some instances closed caption text will overlay portions of the ITV environment thereby causing a conflict.

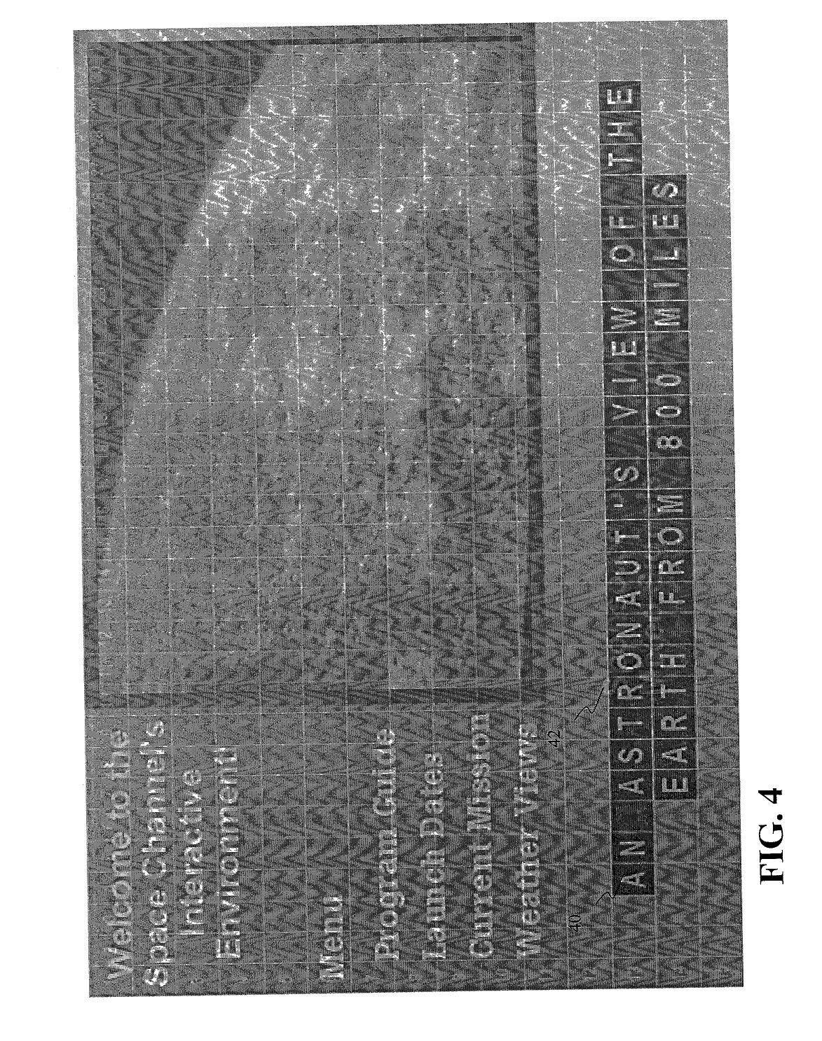

Conflict between closed caption text and ITV data may occur because the creator of the closed caption text has no prior knowledge, or concern, of where interactive TV elements may be placed on screen. FIG. 4 illustrates a closed caption 40 displayed outside the video image and overlayed on an ITV advertisement 42. To avoid these types of conflicts, conventional ITV receivers often filter closed caption data, removing it from the signal that is forwarded to the TV receiver when an interactive program is being viewed. The filtering of the closed captions prevents closed captions from being displayed on screen during that program.

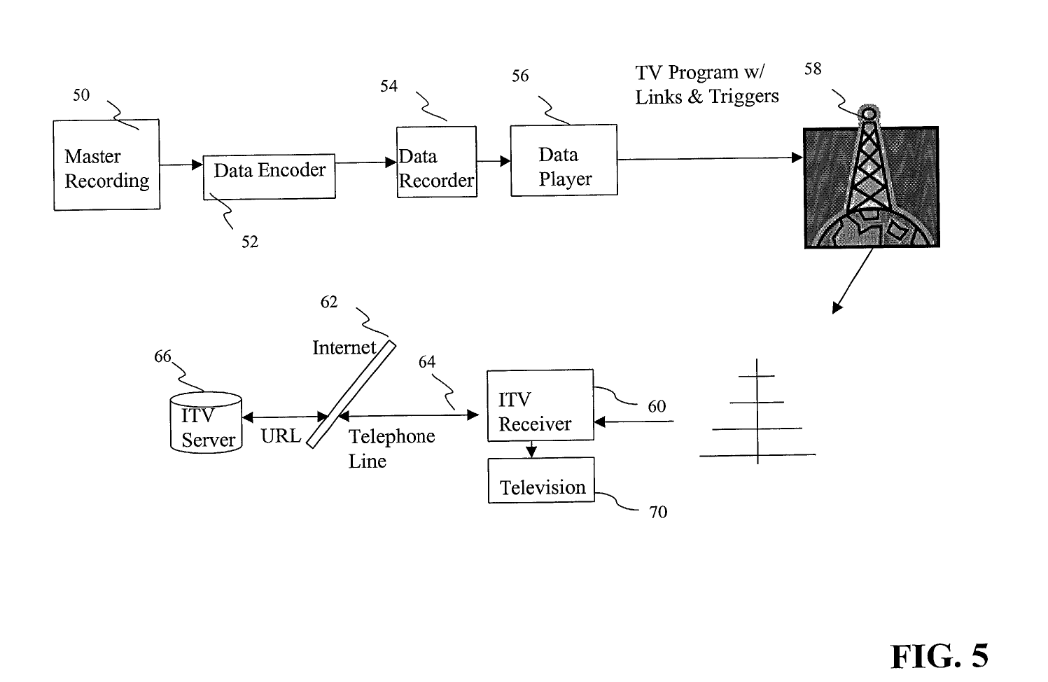

An exemplary embodiment of the present invention provides a method for repositioning the closed caption text in an area of the TV screen defined by the ITV author, thereby restoring the closed caption service for interactive TV programs. The advantages of the present invention may best be illustrated in the context of an exemplary ITV system. FIG. 5 illustrates the overall signal and data flow for an exemplary interactive TV system. During the production phase of a TV program or commercial, the program is edited from one or more master recordings 50. In accordance with an exemplary embodiment a data encoder 52 may embed certain URL links and command triggers into the program. In one embodiment the data encoder may embed the URL links and command triggers in the vertical blanking interval (VBI) of the video portion of the program. The modified program is recorded by a data recorder 54 for subsequent broadcast.

When desired, the modified TV program is broadcast, along with the embedded URLs and/or command triggers, by means of a data player 56 and broadcast station 58. These URLs and triggers cause an ITV receiver 60 in a viewer's home to retrieve enhanced content from the Internet 62 by way of a telephone interface 64. In the described exemplary embodiment the telephone interface provides two way communication between the viewer and an ITV server 66. The telephone interface may also provide the majority of the interactive content as the bandwidth reserved for ITV data in today's TV transmissions is often very low.

The ITV receiver 60 receives and decodes the ITV data in the form of, for example, Uniform Resource Locators (“URLs”) triggers (e.g., Java-script program calls), and/or other commands, which may then be used to access the interactive content from a remote location. The TV program, along with the retrieved content, may then be displayed on a television or other display 70.

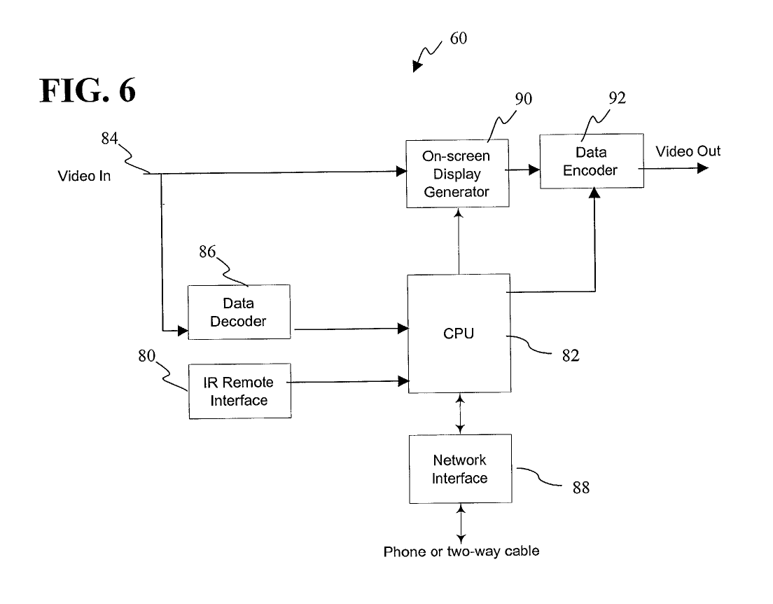

FIG. 6 illustrates an exemplary ITV receiver 60 that may incorporate the described exemplary method for integrating closed captions into an ITV environment. One of skill in the art will appreciate that the present invention is not limited to a particular type of ITV receiver or ITV system. Rather, the present invention may be integrated into all ITV receivers to provide closed caption capability in an ITV environment. For example, the present invention may be integrated into stand alone units such as the WebTV or AOLTV receivers. Similarly the present invention may also be utilized by integrated systems such as the DishPlayer from Dish Networks which contains WebTV functionality. Further, the present invention may be incorporated into ITV receivers that utilize an analog video sources such as the WebTV or AOLTV units as well receivers that utilize compressed MPEG digital video sources, such as the DCT2000 from Motorola (formally General Instruments) running ITV “middleware” software.

The described exemplary ITV receiver may include an infrared remote interface 80 or other interface to allow for the reception of input commands from a system user. An exemplary remote interface includes an IR receiver (not shown) that converts the received optical signals to an electrical output that is forwarded to a central processing unit (CPU) 82 for interpretation. In accordance with an exemplary embodiment the CPU 82 may be for example, a MIPS, ARM, Pentium or other processors known in the art. The CPU 82 processes user inputs and controls the various peripherals of the ITV receiver, such as channel changing and modem functions.

In the described exemplary embodiment an incoming video signal 84 contains a source of ITV data as well as closed caption information. The incoming video signal is forwarded to a data decoder 86 that recovers the ITV data and the closed caption data from the incoming video. For analog solutions, the data decoder recovers data from the vertical blanking interval of the video signal (scan lines 10-21). For digital solutions, the decoder recovers data that is addressed with a unique packet ID.

The ITV data may include, for example, URLs that point the ITV receiver 60 to externally located HTML pages, or, the data may contain the actual ITV content. In the described exemplary embodiment the closed caption data comprises screen addressing control codes, spaces, and text. The data decoder 86 forwards the ITV data and the closed caption data to the CPU 82 for processing. In the described exemplary embodiment a network interface 88 provides a connection to the Internet through which the CPU 82 may retrieve external ITV content and report information about the user. The network interface 88 may be facilitated via a dial-up connection, or it may be an interface to a two way data transfer system in a cable TV environment. Alternatively, the described exemplary ITV receiver may contain an Ethernet port that connects directly to the Internet or local area network that has access to the Internet.

In accordance with an exemplary embodiment, the CPU 82 interprets the ITV code and closed captioning screen address control codes to determine screen positioning of the ITV data and the caption data. The described exemplary CPU 82 may then determine whether a conflict exists between the screen position of the ITV data and the closed caption data. An exemplary CPU may then modify at least a portion of the closed caption positioning control codes and spaces to cause the captions to be displayed in area of the screen that does not conflict with the ITV data. In one embodiment the CPU 82 may forward the modified closed caption data to a data encoder 92 that encodes the closed caption data with modified control codes into the outgoing video signal. Alternatively, the CPU may forward the closed caption data having modified control codes to an on screen display generator 90 that burns the closed caption into the video signal. In this embodiment, a viewer could enable or disable the display of closed captions via the remote interface 80.

In the described exemplary embodiment, the CPU 82 runs a form of a browser that interprets and renders ITV content and forwards appropriate content to the on screen display generator 90. The on screen display generator 90 overlays text and graphical information on top of the video signal 84 and outputs an ITV program for display on a television or other display (see FIG. 5).

Typical television receivers employ customer selectable modes of operation for television and caption. In operation, when a viewer activates the caption mode on his/her television set, the caption text is displayed on the television screen. The text is displayed in a format prescribed by the author of the closed captions. There are three styles of presenting text in caption mode, namely roll-up, pop-on, and paint-on style captioning.

Roll-up style captioning may simultaneously display either two, three or four contiguous rows of text. Each time a carriage return is received, the text in the top row of the window is erased from memory and from the display or scrolled off the top of the window. The remaining rows of text are each rolled up into the next highest row in the window, leaving the base row blank and ready to accept new text. The roll-up rate is timed so as to appear smooth to the user.

Pop-on style captioning is initiated by receipt of a resume caption loading command. Subsequent data are loaded into a non-displayed memory and held there until an end of caption command is received, at which point the non-displayed memory becomes the displayed memory and vice versa. Paint-on style captioning immediately addresses data to displayed memory without need for an end of caption command.

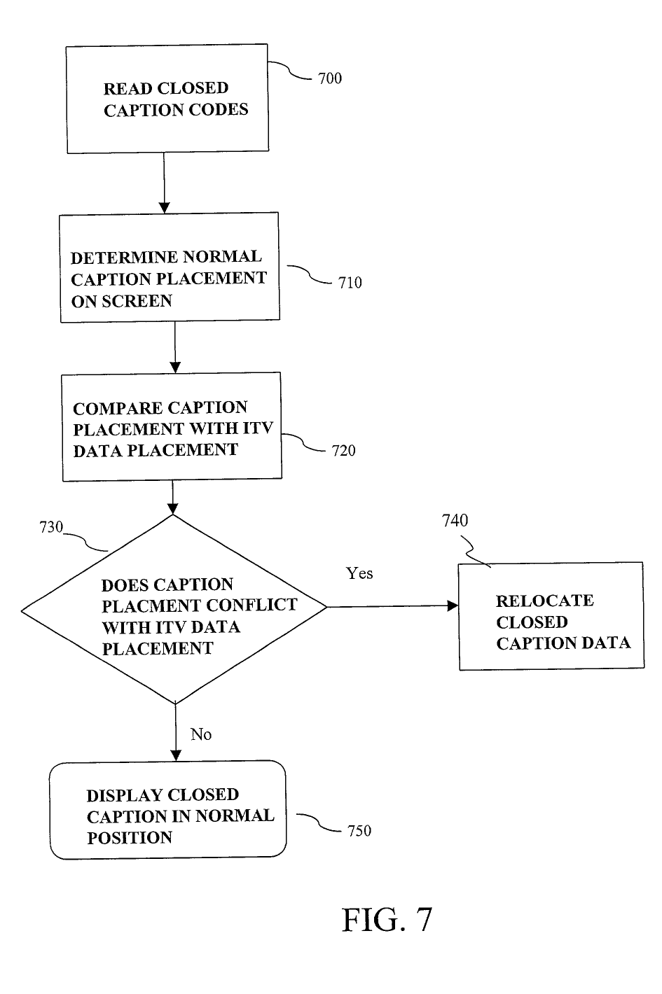

An exemplary embodiment of the present invention provides a method for repositioning the closed caption text in an area of the TV screen defined by the ITV author, thereby restoring closed caption service for interactive TV programs. In accordance with an exemplary embodiment closed caption text is positioned by using a series of two byte control codes that precede the text. Default positions may also be defined when no addressing code is provided. In addition, spaces may also be used to horizontally locate captions. Referring to FIG. 7, in an exemplary embodiment of the present invention an ITV receiver reads the closed caption control codes 700. The described exemplary receiver examines the screen addressing control codes, spaces, and text to determine screen positioning of the caption data 710 as broadcast.

In an exemplary embodiment of the present invention an ITV content provider allocates an area of the TV screen for placement of closed captioning content. The ITV receiver then, knowing where space is allocated in a particular ITV environment, compares the screen position of the closed caption data with the screen position of the ITV data 720 to determine if a conflict exists 730. The described exemplary ITV receiver does not relocate the closed caption data if its display position does not conflict with the display of the ITV data 750. However, if a conflict does exist between the screen position of the closed caption data as broadcast and the ITV data, the receiver may modify certain positioning control codes and spaces to cause the caption data to be displayed in the area allocated for placement of closed captions 740.

In accordance with an exemplary embodiment, the ITV receiver may utilize standard EIA-608 positioning control codes to control the placement of the closed caption data. Appendix A attached hereto and incorporated herein by reference includes a comprehensive list of control codes that may be utilized by an exemplary receiver. One of skill in the art will appreciate that the present invention is not limited to the use of EIA-608 positioning control codes, but may utilize any positioning codes to control the placement of the closed caption data. Therefore the described exemplary positioning control codes are by way of example only and not by way of limitation.

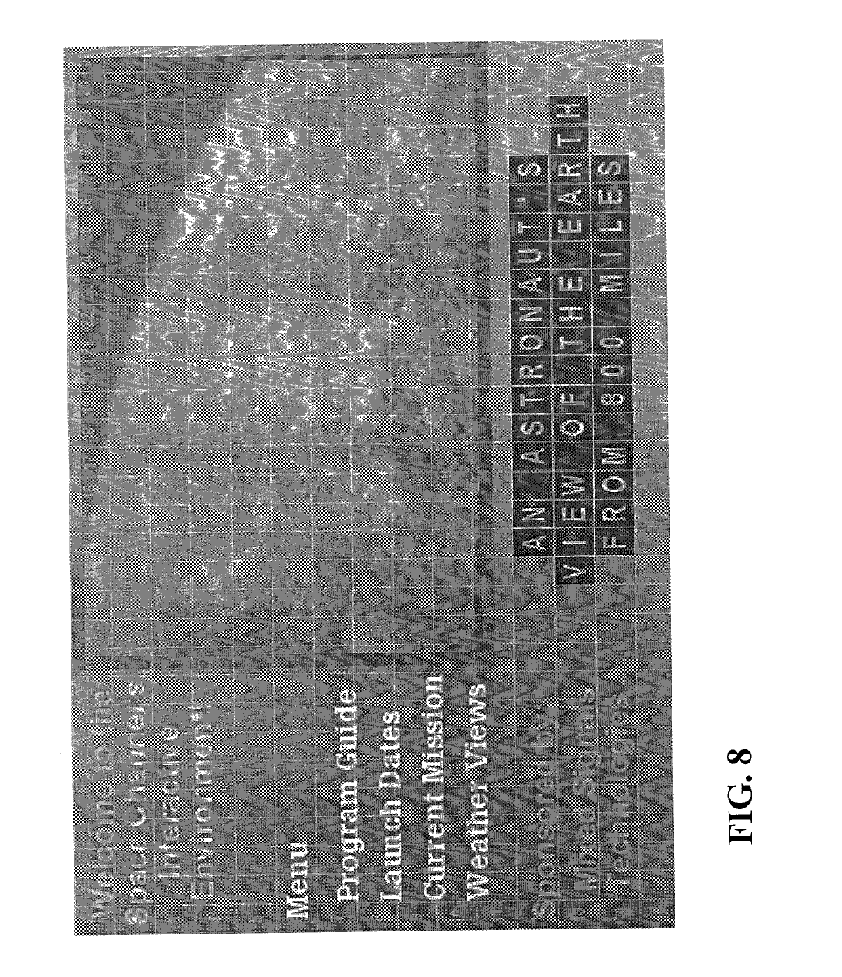

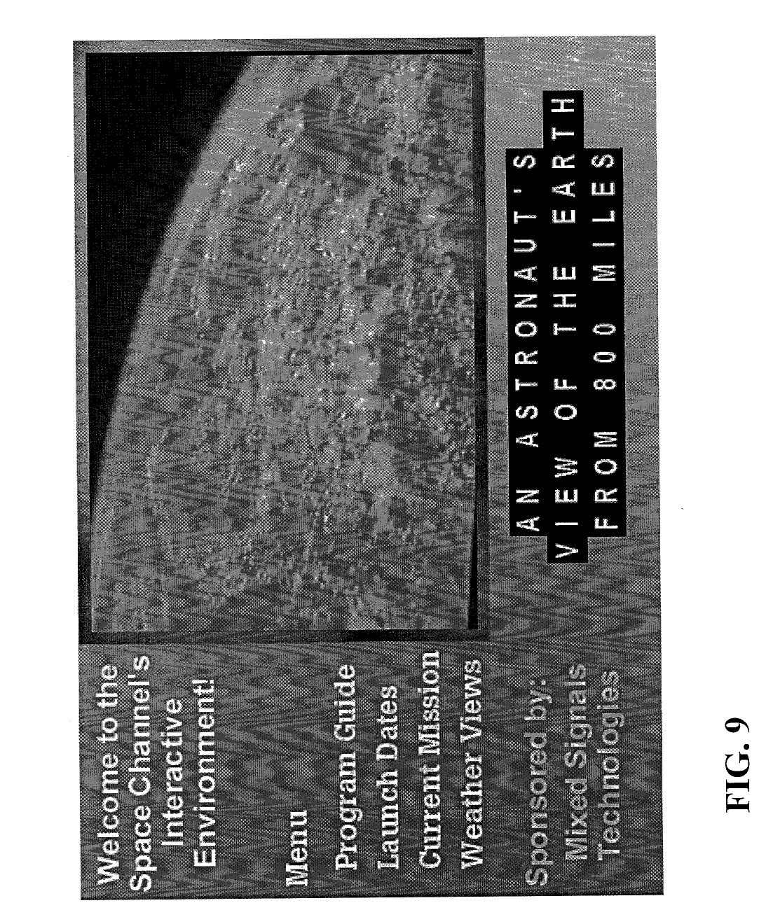

In some cases, an exemplary ITV receiver may add carriage returns to the caption data to divide a caption into smaller lines because the area allocated for the display of captions by the ITV author may not encompass all 31 columns. FIG. 8 illustrates the addition of carriages returns to reduce the line length of the caption displayed in FIG. 4. In this example the caption has been increased to three rows for display within an allocated area that is roughly from column 11 to column 30. FIG. 9 shows the resulting display. In addition, an exemplary ITV receiver may convert the captions from the pop-on presentation style to the roll-up style in order to display all of the text in the allotted time (the time specified by the caption author).

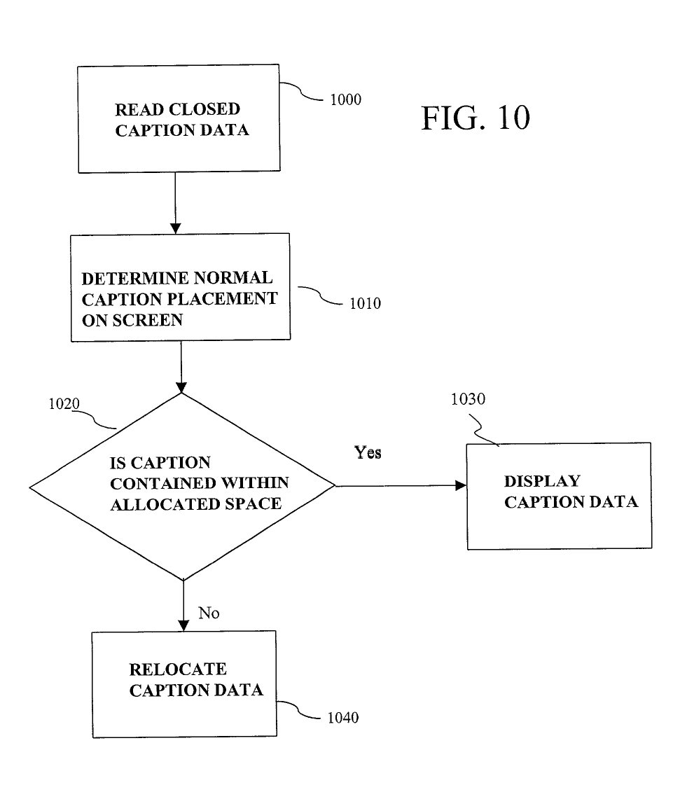

Referring to FIG. 10, in another embodiment of the present invention, the ITV content provider again allocates an area of the display screen for placement of closed caption data. The described exemplary ITV receiver reads the closed caption data 1000 and examines the screen addressing control codes, spaces, and text to determine the screen position of the caption data 1010 as broadcast. Knowing where space is allocated in a particular ITV environment, the described exemplary ITV receiver may then determine if the caption data as broadcast is contained within the screen area allocated for the display of caption data 1020. If so the described exemplary ITV receiver may simply display the caption data as broadcast 1030. Otherwise the described exemplary ITV receiver relocates the caption data to the allocated screen space 1040. In accordance with an exemplary embodiment, the ITV receiver may modify certain positioning control codes and spaces to cause the captions to be displayed in a screen area allocated for the display of closed caption.

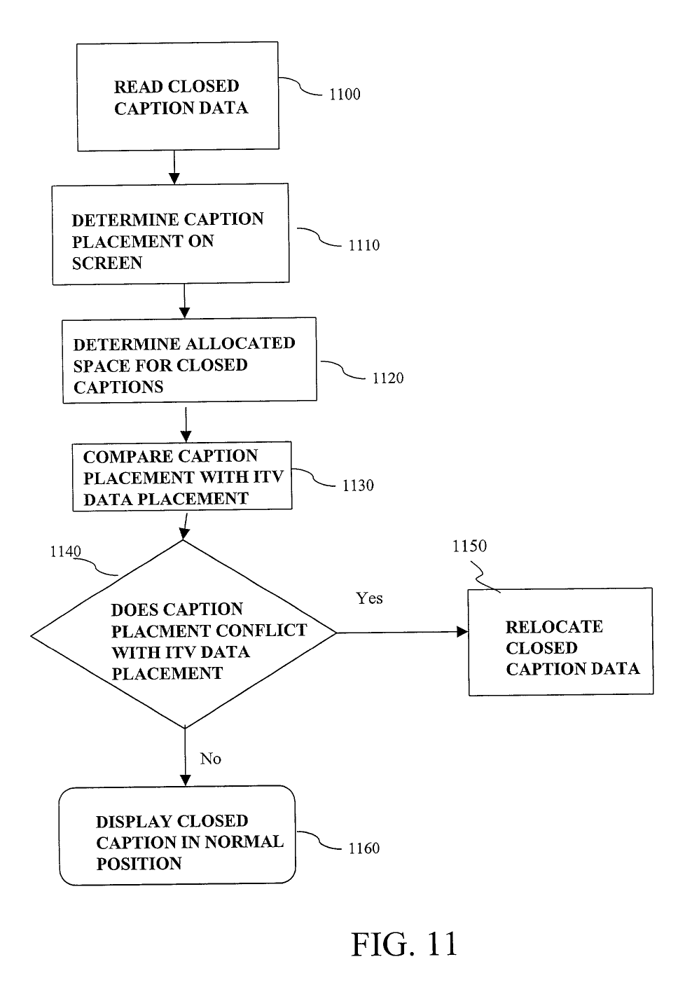

Referring to FIG. 11, in another embodiment of the present invention, the ITV content provider allocates a given number of rows and columns within which closed caption data may be displayed. However, in this embodiment the dedicated screen area may be located anywhere on the TV screen. In this embodiment an ITV receiver reads the closed caption data 1100 and examines the screen addressing control codes, spaces, and text to determine the screen positioning of the closed caption data 1110. The described exemplary ITV receiver may also determine the location of the screen area allocated for presentation of closed captioning 1120. In one embodiment the ITV content creator may provide control codes that specify the location of the allocated space.

In accordance with an exemplary embodiment, the ITV receiver may then compare the screen position of the closed caption data with the screen position of the ITV data 1130 to determine if a conflict exists 1140. If a conflict exists between the closed captioning placed in its normal position, and the ITV data, an exemplary ITV receiver may modify certain control codes and spaces to cause the closed caption data to be displayed in the area allocated for the display of closed captions 1150. In accordance with an exemplary embodiment, the ITV receiver does not alter the position control codes of the closed caption data if its screen position does not conflict with the screen position of the ITV data 1160.

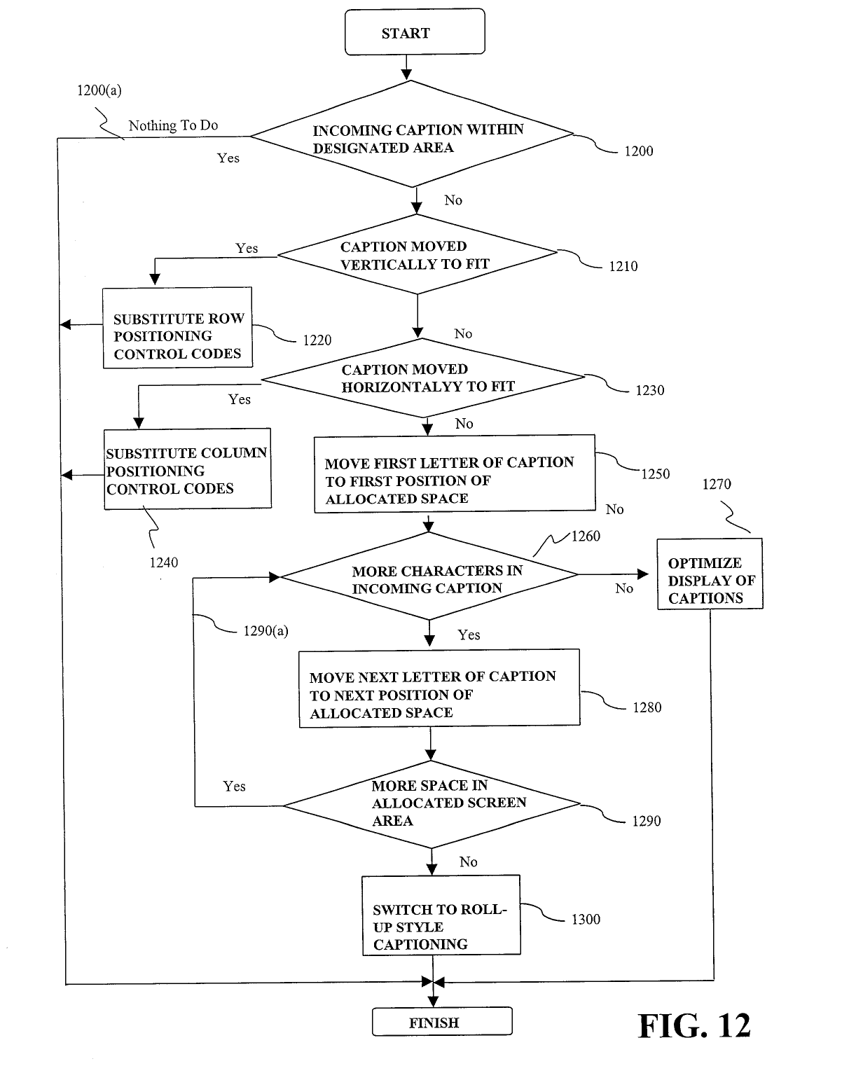

FIG. 12 is a flow chart graphically illustrating a method for modifying the positioning control codes of closed caption data to locate the closed caption data in an area of a display screen defined by the ITV author. In accordance with an exemplary embodiment, an ITV receiver may first determine if the incoming caption is positioned within the screen area allocated for the display of closed caption data 1200. If so, no conflict exists with the ITV data and an exemplary ITV receiver does not modify the positioning control codes of the closed caption 1200(a).

However, an exemplary ITV receiver may modify the positioning control codes of closed captions that are not contained within the screen area allocated for the display of closed captions. In operation, an exemplary ITV receiver may first determine if the closed caption as broadcast will fit in the allocated area without modifying the horizontal placement of characters 1210. If so, the described exemplary ITV receiver may modify the row positioning control codes to relocate the closed caption within the screen area allocated for the display of captions 1220.

If the caption can not be vertically repositioned so as to fit within the area allocated for the display of closed captions, the described exemplary ITV receiver may determine whether the caption may be repositioned horizontally so as to fit within the screen area designated for the display of closed captions 1230. If so, the described exemplary ITV receiver may modify the column positioning control codes 1240 to relocate the closed caption within the area allocated for the display of captions.

If not the described exemplary ITV receiver may resize the caption before relocating it to the screen area allocated for the display of closed captions. In accordance with an exemplary embodiment, an ITV receiver may relocate the first character of the incoming closed caption to the first grid position of the screen area allocated for the display of closed captions 1250. The described exemplary receiver may then determine whether there are more characters in the incoming caption 1260.

If not, an exemplary ITV receiver may optimize the display of the caption 1270. For example, the caption may be modified to have even rows and text centered within the screen area allocated for the display of caption data. If there are additional characters in the incoming caption, an exemplary receiver may relocate the next character of the incoming caption to the next position of the allocated screen area 1280. The described exemplary embodiment may determine if there is additional space in the screen area allocated for the display of closed captions 1290. If there is no more space remaining in the allocated screen area, an exemplary ITV receiver may utilize a roll-up style to display the caption 1300.

If there is additional space remaining in the screen area allocated for the display of captions 1290(a) the ITV receiver will again determine whether there are additional characters in the caption 1260 and if so relocate the next character to the next position of the allocated screen area 1280. In the described exemplary embodiment, the relocation of closed caption characters continues until all of the characters of the incoming caption are relocated or until there is no more space in the screen area allocated for the display of closed captions in which case the ITV receiver switches to roll-up style captioning.

The described exemplary method for relocating closed captions may be best illustrated by a series of illustrative examples. In a first example it is assumed that a ITV content creator allocates a rectangular screen area bound by the grid coordinates of row 13 column 4 and row 14 column 28 for the display of closed caption. Further, for the purposes of illustration assume the following positioning control codes and text are received by the described exemplary ITV receiver.

14 20 11 72 11 39 And now, a few words 12 54 14 21 from our sponsors. 14 2F

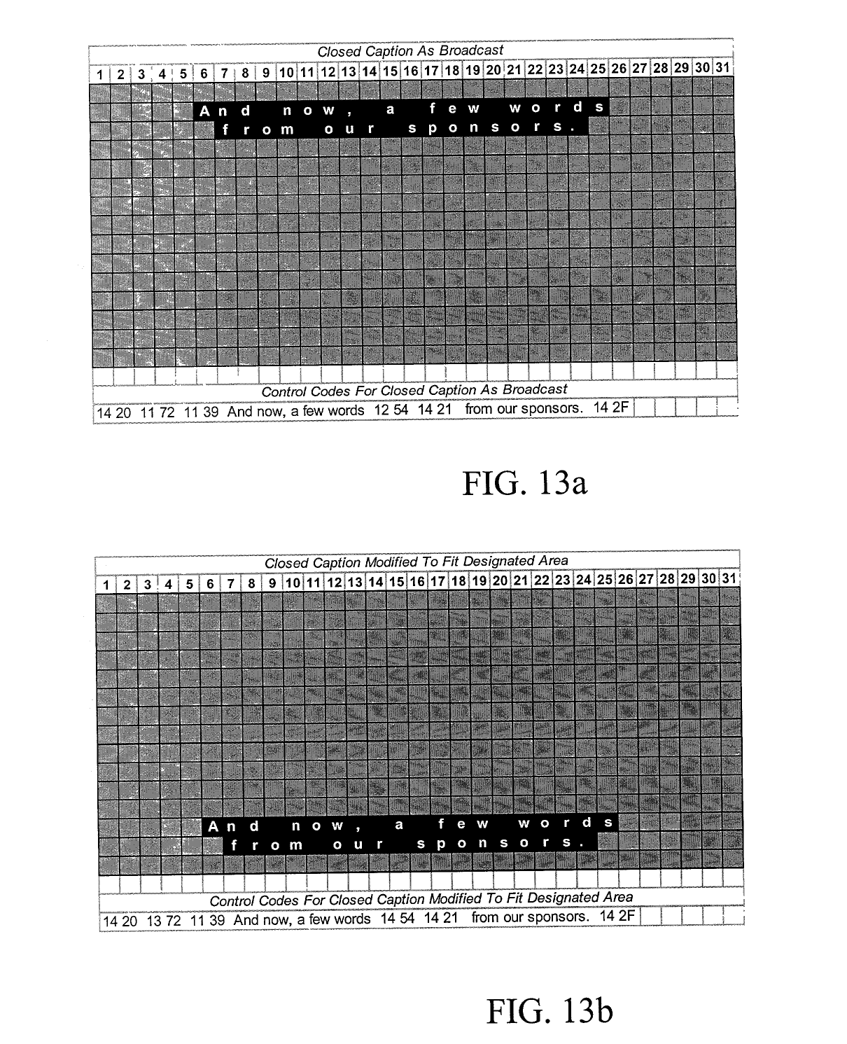

Referring to the EIA-608 control code tables contained in index A, the code “14 20” is a “resume caption loading” command that prompts the ITV receiver to load the received caption. The code “11 72” is a preamble address code that locates the beginning of the caption at row 2, with an indent of 4 columns. The code “11 39” is a transparent space so that the first row of caption text “And now, a few words” is displayed on row 2, beginning at column five as illustrated in FIG. 13a. Similarly, the mid row code “12 54” is a preamble address code that locates the beginning of the second row of text at row 3 with an indent of 8 columns. The code “14 21” is a backspace command so that the second row of caption text “from our sponsors.” is displayed on row 3, beginning at column 7 as illustrated in FIG. 13a. The code “12 2F” is an end of caption command.

Thus the caption as broadcast is outside of the screen area designated for the display of closed captions. Therefore, the described exemplary ITV receiver may determine whether the closed caption as broadcast will fit in the designated screen area without modifying the horizontal placement of caption characters. In this case the caption is horizontally bound by columns 6 and 25 which fit within the screen area designated for caption display which is bound by columns 4 and 28. Therefore, the described exemplary ITV receiver replaces the row 2 and row 3 positioning codes, 11 and 12 respectively, with codes for row 13 and row 14, positioning codes 13 and 14 respectively. In this instance the closed caption will now be displayed within the screen area designated for the display of closed captions as illustrated in FIG. 13b.

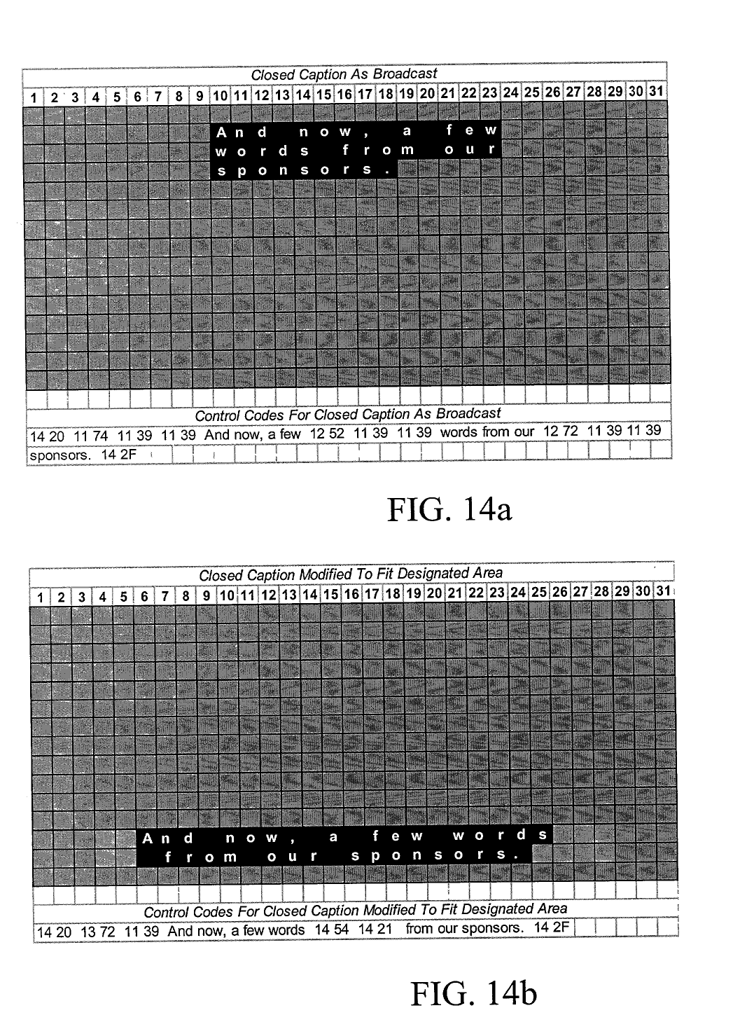

FIGS. 14a and 14b provide an additional example of the modification of positioning codes to relocate a closed caption in an area allocated for the display of captions. In this example it is again assumed that the allocated area is bound by grid coordinates row 13 column 4 and row 14 column 28. It is further assumed that a caption comprising three rows of text, having the following positioning control codes, is received by the described exemplary ITV receiver.

14 20 11 74 11 39 11 39 And now, a few 12 52 11 39 11 39 words from our 12 72 11 39 11 39 sponsors. 14 2F

In this example the caption as broadcast is horizontally bound by grid columns 10 and 23 and will therefore fit within the area allocated for the display of captions which is bound by grid columns 4 and 28. However, in this example the incoming caption comprises three rows and will not therefore fit within rows 13 and 14 that have been allocated for the display of captions. Therefore, the described exemplary ITV receiver modifies the positioning control codes for the incoming three row, thirteen column caption for display in the two row, twenty five column area allocated for the display of captions in the ITV environment as illustrated in FIG. 14b. In operation, if the ITV receiver had not been able to modify the caption to fit within the area allocated for the display of captions, the ITV receiver would have switched to the roll-up mode of closed caption display.

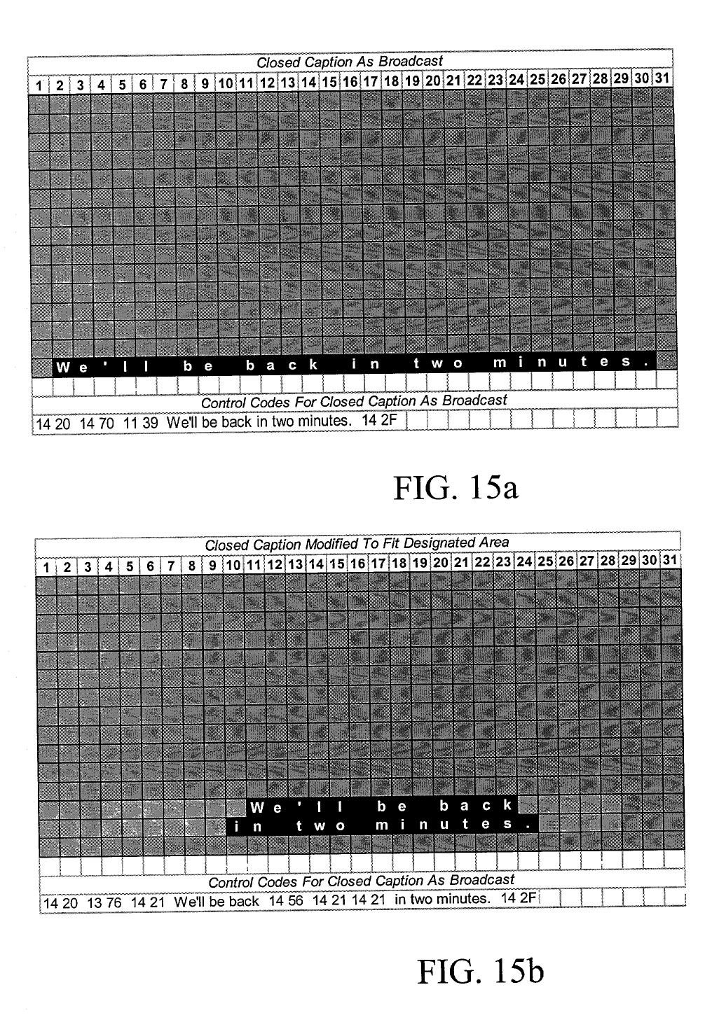

FIGS. 15a and 15b provide an additional example of the modification of positioning codes to relocate a closed caption in a screen area allocated for the display of captions. In this example it is again assumed that the allocated area is bound by grid coordinates row 13 column 4 and row 14 column 28. It is further assumed that a caption comprising one row of text having the following positioning control codes is received by the described exemplary ITV receiver.

14 20 14 70 11 39 We'll be back in two minutes. 14 2F

In this example the horizontal extent of the caption as broadcast, i.e. twenty eight columns, is wider than the twenty five columns allocated for the display of captions. Therefore, the described exemplary ITV receiver modifies the positioning control codes to display the caption in two rows within the area allocated for the display of captions as illustrated in FIG. 15b.

Although a preferred embodiment of the present invention has been described, it should not be construed to limit the scope of the appended claims. Those skilled in the art will understand that various modifications may be made to the described embodiment. Moreover, to those skilled in the various arts, the invention itself herein will suggest solutions to other tasks and adaptations for other applications. It is therefore desired that the present embodiments be considered in all respects as illustrative and not restrictive, reference being made to the appended claims rather than the foregoing description to indicate the scope of the invention.

What is claimed is:

1. A method of displaying closed captions encoded in a video signal, comprising the steps of:
allocating a screen area for displaying the closed captions;
receiving said video signal and ITV data; and
relocating said closed captions to said allocated screen area.

2. The method of claim 1 wherein the step of relocating said closed captions comprises modifying one or more screen address control codes to relocate said closed captions to the allocated screen area.

3. The method of claim 2 further comprising reformatting said closed captions for display within the allocated screen area.

4. The met hod of claim 3 wherein the step of reformatting said closed captions comprises adding one or more carriage returns to said closed captions for display in a predetermined number of columns.

5. The method of claim 3 wherein the step of reformatting said closed captions comprises altering style of text presentation.

6. The method of claim 5 wherein the step of altering the style of text presentation comprises presenting closed captions in a roll up caption mode.

7. The method of claim 1 wherein the step of relocating said closed captions comprises determining if a conflict exists between screen location of the closed captions and the ITV data and relocating said closed captions to said allocated screen area in accordance with said conflict determination.

8. The method of claim 7 wherein the step of determining if a conflict exists comprises determining location of said closed captions and said ITV data and comparing said locations.

9. A method of displaying closed captions encoded in a video signal, comprising the steps of:
receiving said video signal and ITV data;
determining if a conflict exists between screen location of the closed captions and screen location of the ITV data; and
relocating the closed captions in accordance with said conflict determination.

10. The method of claim 9 wherein the step of relocating said closed captions comprises modifying one or more screen address control codes to relocate said closed captions to a screen area reserved for displaying said closed captions.

11. The method of claim 10 further comprising the step of reformatting said closed captions for display within the screen area reserved for displaying closed captions.

12. The method of claim 11 wherein the step of reformatting said closed captions comprises adding one or more carriage returns to said closed captions for display in a predetermined number of columns.

13. The method of claim 11 wherein the step of reformatting said closed captions comprises altering style of text presentation.

14. The method of claim 13 wherein the step of altering the style of text presentation comprises presenting closed captions in a roll up caption mode.

15. The method of claim 9 wherein the step of relocating said closed captions comprises relocating said closed captions to a predetermined screen location.

16. A method of displaying closed captions encoded in a video signal, comprising the steps of:
receiving said video signal and ITV data;
determining screen location of the closed captions;
determining screen location of the ITV data; and
relocating at least a portion of the closed captions whose screen location conflicts with the screen location of said ITV data.

17. The method of claim 16 wherein the step of relocating said closed captions comprises modifying one or more screen address control codes to relocate said closed captions to a screen area reserved for displaying said closed captions.

18. The method of claim 17 further comprising the step of determining location of the reserved screen area.

19. The method of claim 17 further comprising the step of reformatting said closed captions for display within the screen area reserved for displaying closed captions.

20. The method of claim 19 wherein the step of reformatting said closed captions comprises adding one or more carriage returns to said closed captions for display in a predetermined number of columns.

21. The method of claim 19 wherein the step of reformatting said closed captions comprises altering style of text presentation.

22. The method of claim 21 wherein the step of altering the style of text presentation comprises presenting closed captions in a roll up caption mode.

23. An interactive television receiver, comprising:
means for allocating a screen area for displaying closed captions;
means for receiving said video signal;
means for receiving ITV data; and
means for relocating said closed captions to said allocated screen area.

24. The interactive television receiver of claim 23 wherein the means for relocating said closed captions comprises means for modifying one or more screen address control codes to relocate said closed captions to the allocated screen area.

25. The interactive television receiver of claim 24 further comprising means for reformatting said closed captions for display within the allocated screen area.

26. The interactive television receiver of claim 25 wherein the means for reformatting said closed captions comprises means for adding one or more carriage returns to said closed captions for display in a predetermined number of columns.

27. The interactive television receiver of claim 25 wherein the means for reformatting said closed captions comprises means for altering style of text presentation.

28. The interactive television receiver of claim 27 wherein the means for altering the style of text presentation comprises means for presenting closed captions in a roll up caption mode.

29. The interactive television receiver of claim 23 wherein the means for relocating said closed captions comprises means for determining if a conflict exists between screen location of the closed captions and the ITV data and wherein said closed captions are relocated to said allocated screen area in accordance with said conflict determination.

30. The interactive television receiver of claim 29 wherein the means for determining if a conflict exists comprises means for determining location of said closed captions and said ITV data and means for comparing said locations.
